(19) United States
(12) Patent Application Publication
(10) Pub. No.: US 2023/0185876 A1
(43) Pub. Date: Jun. 15, 2023

(54) MULTIDIMENSIONAL DATA GENERATION DEVICE, METHOD, AND COMPUTER-READABLE RECORDING MEDIUM

(71) Applicant: NEC Corporation, Minato-ku, Tokyo (JP)

(72) Inventor: Seiya Shibata, Tokyo (JP)

(73) Assignee: NEC Corporation, Minato-ku, Tokyo (JP)

(21) Appl. No.: 17/925,657

(22) PCT Filed: May 25, 2020
(86) PCT No.: PCT/JP2020/020568

§ 371 Date: Nov. 16, 2022

(51) Int. Cl. G06F 17/16; G06F 7/78

(52) U.S. Cl. CPC G06F 17/16; G06F 7/78

(57) ABSTRACT

The transforming means 72 transforms first multidimensional data in which the number of elements of dimension of channel is C and the number of elements of each dimension other than the dimension of channel is 1 into second multidimension of a predetermined form. The channel dimension element number increase means 73 generates third multidimensional data in which the number of elements of the dimension of channel is increased from 1 to N, by performing a convolution layer process with a filter size of 1×1. The transposition means 74 performs transposition on the third multidimensional data so that the number of elements of the dimension of channel becomes C. The generation means 75 generates multidimensional data in which the number of elements of the dimension of channel is C and the number of elements of each dimension other than the dimension of channel is predetermined number of elements.

### TECHNICAL FIELD

The present invention relates to a multidimensional data generation device and a multidimensional data generation method that generates multidimensional data, and a computer-readable recording medium recording a multidimensional data generation program.

### BACKGROUND ART

In a neural network, a block is a batch of multiple layers which are basic components.

NPL 1 describes a SE (Squeeze-and-Excitation) block, as a block that improves the accuracy of CNN (Convolutional Neural Network). FIG. 12 is a schematic diagram showing the SE block described in NPL 1. NPL 1 shows the case where 3 dimensional data U corresponding to one input data, as multidimensional data corresponding to one input data, is input to the SE block. FIG. 13 is a schematic diagram showing the 3 dimensional data U input to the SE block.

The individual dimensions in the 3 dimensional data are referred to as the H dimension, the W dimension, and the C dimension. The H dimension is, for example, the dimension related to the height of an image. The W dimension is, for example, the dimension related to the width of the image. The C dimension is the dimension related to the channel. It is assumed that the number of elements of the H dimension in the 3 dimensional data U is H. It is assumed that the number of elements of the W dimension in the 3 dimensional data U is W. It is assumed that the number of elements of the C dimension in the 3 dimensional data U is C. The size of the 3 dimensional data U can be expressed as H×W×C.

The size of the 3 dimensional data may be expressed in parentheses as “(number of elements of the H dimension, number of elements of the W dimension, number of elements of the C dimension)”, in addition to the notation “H×W×C”. The order of H, W, and C in the notation “H×W×C” or the order of “number of elements of the H dimension”, “number of elements of the W dimension”, and “number of elements of the C dimension” in the notation of “(number of elements of the H dimension, number of elements of the W dimension, number of elements of the C dimension)” is not limited to the order described herein.

In the Global Pooling layer (step S101), the number of elements of the H dimension and the W dimension are respectively 1. The number of elements of the C dimension remains unchanged at C. In other words, based on the 3 dimensional data U whose size is H×W×C, 1 dimensional data whose size is 1×1×C is generated. FIG. 14 is a schematic diagram showing the 1 dimensional data obtained in the Global Pooling layer.

In the first FC (Fully Connected) layer (step S102), the number of elements in the 1 dimensional data obtained in the Global Pooling layer is reduced. FIG. 15 is a schematic diagram showing the 1 dimensional data obtained in the FC layer. Here, the number of elements after the reduction is A. A<C.

FIG. 16 is a schematic diagram showing the process in the first FC layer (step S102). In the first FC layer (step S102), the number of elements that are outputs is less than the number of elements that are inputs. Then, the elements that are inputs and the elements that are outputs are fully connected as shown in FIG. 16, and weights are determined for respective individual connections. When the number of elements that are inputs is C and the number of elements that are outputs is A, the number of weights is C×A. Each weight is determined in advance by learning. The value of an element that is an output is calculated based on the values of the individual elements that are inputs connected with the element and the weights determined for each pair of the element that is an output and the individual element that is an input. By finding the values of the A elements that are outputs, 1 dimensional data (see FIG. 15) whose number of elements is A is obtained.

In the ReLU (Rectified Linear Unit) layer (Step S103), among the elements in the 1 dimensional data obtained in the FC layer (Step S102), the values of elements with negative values are changed to 0. The values of elements with values equal to or greater than 0 are not changed. In the ReLU layer, the number of elements in 1 dimensional data remains unchanged at A.

In the second FC layer (step S104), the number of elements in the 1 dimensional data obtained in the ReLU layer is increased back to the original number of elements (C elements).

FIG. 17 is a schematic diagram showing the process in the second FC layer (step S104). In the second FC layer (step S104), the number of elements that are outputs is greater than the number of elements that are inputs. Then, the elements that are inputs and the elements that are outputs are fully connected as shown in FIG. 17, and weights are determined for respective individual connections. When the number of elements that are inputs is A and the number of elements that are outputs is C, the number of weights is A×C. Each weight is determined in advance by learning. The value of an element that is an output is calculated based on the values of the individual elements that are inputs connected with the element and the weights determined for each pair of the element that is an output and the individual element that is an input. By finding the values of the C elements that are outputs, 1 dimensional data whose number of elements is C is obtained.

The first FC layer and the second FC layer differ only in whether the number of elements that are outputs decreases or increases with respect to the number of elements that are inputs; the essential process is the same.

In the Sigmoid layer (step S105), the sigmoid function is applied to each element in the 1 dimensional data obtained in the second FC layer. In the Sigmoid layer, the number of elements in the 1 dimensional data remains unchanged at C.

Individual elements in the 1 dimensional data obtained by the Sigmoid layer are used as coefficients representing the degree of importance of the channel corresponding to the individual element. For example, the 0th element in the 1 dimensional data is the coefficient representing the degree of importance of the 0th channel.

The output data of the Sigmoid layer can be referred to as 1 dimensional data if viewed as a vector with C elements. This data (data with size 1×1×C) can also be referred to as 3 dimensional data with 1 element of the H dimension, 1 element of the W dimension, and C elements of the C dimension. Hereinafter, the output data of the Sigmoid layer is described as 3 dimensional data with 1 element of the H dimension, 1 element of the W dimension, and C elements of the C dimension.

In the Scale layer (step S106), the elements of each channel in the first input 3 dimensional data U (see FIG. 13) are multiplied by a coefficient indicating the degree of importance of that channel. At this time, by copying the 3 dimensional data obtained in the Sigmoid layer H×W times, 3 dimensional data whose size is H×W×C is generated. This 3 dimensional data is denoted by a symbol X′. Since the size of the 3 dimensional data obtained in the Sigmoid layer is 1×1×C, by copying this 3 dimensional data H×W times, 3 dimensional data X′ with size H×W×C is obtained. FIG. 18 is a schematic diagram showing the 3 dimensional data X′ obtained by copying the 3 dimensional data of size 1×1×C, H×W times. FIG. 19 is a schematic diagram showing calculation of element-wise product of the 3 dimensional data U and the 3 dimensional data X′. The sizes of both the 3 dimensional data U and the 3 dimensional data X′ are H×W×C and are common. Furthermore, the elements in the 3 dimensional data U and the elements in the 3 dimensional data X′ can both be specified by 3 dimension coordinates. Therefore, it is possible to associate elements in the 3 dimensional data U and elements in the 3 dimensional data X′ that share the same 3 dimension coordinates. As a result, the elements in the 3 dimensional data U and the elements in the 3 dimensional data X′ are associated one-to-one. By calculating the product of the values of elements for each pair of elements to be associated, new 3 dimensional data whose size is H×W×C is obtained. This 3 dimensional data is the result of the element-wise product of the 3 dimensional data U and the 3 dimensional data X′, and is the output of the Scale layer. The 3 dimensional data obtained by this element-wise product operation can be said to be the data obtained by multiplying the multiple elements for each individual channel of the 3 dimensional data U by the coefficient corresponding to the channel (coefficient representing the degree of importance).

The output of the Scale layer (element-wise product of the 3 dimensional data U and the 3 dimensional data X′) is also the output of the SE block.

### CITATION LIST

### Non Patent Literature

NPL 1: Jie Hu, Li Shen, Samuel Albanie, Gang Sun, Enhua Wu, “Squeeze-and-Excitation Networks”, [online], [retrieved Apr. 3, 2020], Internet <URL: https://arxiv.org/pdf/1709.01507.pdf>

### SUMMARY OF INVENTION

### Technical Problem

The SE block can improve the accuracy of CNN. However, the SE block can significantly reduce processing speed.

The inventor of the present invention considered the following reasons for the reduced processing speed when SE block is used.

As mentioned above, in the SE block, in the Scale layer, the 3 dimensional data (output data of the Sigmoid layer) whose size is 1×1×C is copied H×W times to obtain the 3 dimensional data X′ (see FIG. 18) whose size is H×W×C. This H×W times copy process causes a large overhead.

In particular, when the number of elements of the C dimension in the output data of the Sigmoid layer is large, the number of times an element is read from a memory and written to the memory becomes enormous, and therefore the overhead of H×W times copy process is also enormous. For example, it is assumed that the size of the 3 dimensional data obtained in the Sigmoid layer is 1×1×1024 (i.e. C=1024). It is assumed that the size of the 3 dimensional data U is 7×7×1024. In other words, H=7 and W=7. In this case, for each of the 1024 elements of the C dimension in the output data of the Sigmoid layer, the read and write processes must be performed 7×7=49 times, resulting in a very large overhead due to the copy process.

The inventor of the present invention considered that the large overhead caused by this copy process was the cause of the slow processing speed in the SE block.

Therefore, it is the object of the present invention to provide a multidimensional data generation device, a multidimensional data generation method, and a computer-readable recording medium recording a multidimensional data generation program that can generate, when given multidimensional data in which the number of elements of the dimension of channel is C and the number of elements of each dimension other than the dimension of channel is 1, multidimensional data in which the number of elements of each dimension other than the dimension of channel is a predetermined number of elements rapidly.

### Solution to Problem

A multidimensional data generation device according to the present invention includes: transformation means for transforming first multidimensional data in which the number of elements of dimension of channel is C and the number of elements of each dimension other than the dimension of channel is 1 into second multidimensional data in which the number of elements of one dimension out of dimensions other than the dimension of channel is C and the number of elements of each dimension other than the one dimension is 1; channel dimension element number increase means for generating third multidimensional data in which the number of elements of the dimension of channel is increased from 1 to N, by performing a convolution layer process with a filter size of 1×1 with a common value of N weights on the second multidimensional data, when product of predetermined number of elements for each dimension other than the dimension of channel is N; transposition means for performing predetermined transposition on the third multidimensional data so that the number of elements of the dimension of channel becomes C; and generation means for generating multidimensional data in which the number of elements of the dimension of channel is C and the number of elements of each dimension other than the dimension of channel is predetermined number of elements, based on the multidimensional data after the predetermined transposition.

A multidimensional data generation method according to the present invention includes: transforming first multidimensional data in which the number of elements of dimension of channel is C the and number of elements of each dimension other than the dimension of channel is 1 into second multidimensional data in which the number of elements of one dimension out of dimensions other than the dimension of channel is C and the number of elements of each dimension other than the one dimension is 1; generating third multidimensional data in which the number of elements of the dimension of channel is increased from 1 to N, by performing a convolution layer process with a filter size of 1×1 with a common value of N weights on the second multidimensional data, when product of predetermined number of elements for each dimension other than the dimension of channel is N; performing predetermined transposition on the third multidimensional data so that the number of elements of the dimension of channel becomes C; and generating multidimensional data in which the number of elements of the dimension of channel is C and the number of elements of each dimension other than the dimension of channel is predetermined number of elements, based on the multidimensional data after the predetermined transposition.

A computer-readable recording medium according to the present invention is a computer-readable recording medium in which a multidimensional data generation program is recorded, wherein the multidimensional data generation program causes a computer to execute: a transformation process of transforming first multidimensional data in which the number of elements of dimension of channel is C and the number of elements of each dimension other than the dimension of channel is 1 into second multidimensional data in which the number of elements of one dimension out of dimensions other than the dimension of channel is C and the number of elements of each dimension other than the one dimension is 1; a channel dimension element number increase process of generating third multidimensional data in which the number of elements of the dimension of channel is increased from 1 to N, by performing a convolution layer process with a filter size of 1×1 with a common value of N weights on the second multidimensional data, when product of predetermined number of elements for each dimension other than the dimension of channel is N; a transposition process of performing predetermined transposition on the third multidimensional data so that the number of elements of the dimension of channel becomes C; and a generation process of generating multidimensional data in which the number of elements of the dimension of channel is C and the number of elements of each dimension other than the dimension of channel is predetermined number of elements, based on the multidimensional data after the predetermined transposition.

### Advantageous Effects of Invention

According to the present invention, it is possible to generate, when given multidimensional data in which the number of elements of the dimension of channel is C and the number of elements of each dimension other than the dimension of channel is 1, multidimensional data in which the number of elements of each dimension other than the dimension of channel is a predetermined number of elements rapidly.

### BRIEF DESCRIPTION OF DRAWINGS

FIG. 1 It depicts a block diagram showing an example configuration of a multidimensional data generation device of the example embodiment of the present invention.

FIG. 2 It depicts a schematic diagram showing an example of first 3 dimensional data.

FIG. 3 It depicts a schematic diagram showing an example of second 3 dimensional data.

FIG. 4 It depicts a schematic diagram showing second 3 dimensional data and third 3 dimensional data.

FIG. 5 It depicts a schematic diagram showing an example of 3 dimensional data after transposing.

FIG. 6 It depicts a schematic diagram showing a state in which H pieces of 3 dimensional data with size (1, W, C) are generated by dividing the 3 dimensional data shown in FIG. 5.

FIG. 7 It depicts a schematic diagram showing 3 dimensional data whose size is (H, W, C), generated by the generation unit 5

FIG. 8 It depicts a schematic diagram showing another example of 3 dimensional data after transposing.

FIG. 9 It depicts a flowchart showing an example of the processing flow of the example embodiment of the present invention.

FIG. 10 It depicts a schematic block diagram showing an example of computer configuration related to the multidimensional data generation device of the example embodiment of the present invention.

FIG. 11 It depicts a block diagram showing an overview of the multidimensional data generation device of the present invention.

FIG. 12 It depicts a schematic diagram showing the SE block.

FIG. 13 It depicts a schematic diagram showing the 3 dimensional data U.

FIG. 14 It depicts a schematic diagram showing the 1 dimensional data obtained in the Global Pooling layer.

FIG. 15 It depicts a schematic diagram showing the 1 dimensional data obtained in the FC layer in the SE block.

FIG. 16 It depicts a schematic diagram showing the process in the first FC layer in the SE block.

FIG. 17 It depicts a schematic diagram showing the process in the second FC layer in the SE block.

FIG. 18 It depicts a schematic diagram showing the 3 dimensional data X′ obtained by copying the 3 dimensional data of size 1×1×C, H×W times.

FIG. 19 It depicts a schematic diagram showing calculation of element-wise product of the 3 dimensional data U and the 3 dimensional data X′.

### DESCRIPTION OF EMBODIMENTS

Example embodiment of the present invention is described below with reference to the drawings.

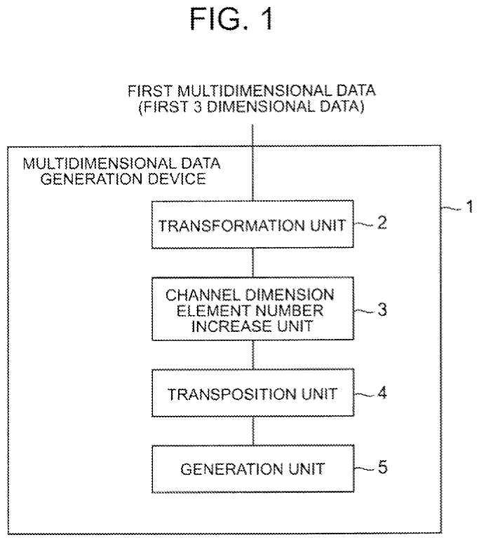

FIG. 1 is a block diagram showing an example configuration of a multidimensional data generation device of the example embodiment of the present invention. The multidimensional data generation device 1 of the present example embodiment includes a transformation unit 2, a channel dimension element number increase unit 3, a transposition unit 4, and a generation unit 5.

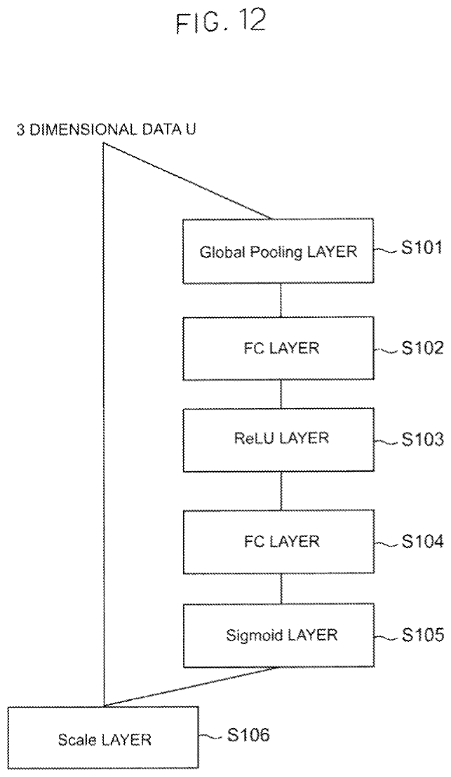

The data input to the multidimensional data generation device 1 of the present example embodiment will now be described. The output data of the Sigmoid layer (see FIG. 12) of the SE block is input to the multidimensional data generation device 1 of the present example embodiment. As already explained, the output data of the Sigmoid layer can be referred to as 3 dimensional data in which the number of elements of the H dimension is 1, the number of elements of the W dimension is 1, and the number of elements of the C dimension is C elements. In other words, the 3 dimensional data in which the number of elements of the H dimension is 1, the number of elements of the W dimension is 1, and the number of elements of the C dimension is C elements is input to the multidimensional data generation device 1. The multidimensional data input to the multidimensional data generation device 1 is referred to as the first multidimensional data (in the present example embodiment, the first 3 dimensional data).

In the first 3 dimensional data, the number of elements of the C dimension (the dimension of channel) is C and the number of elements of each dimension other than the C dimension is 1.

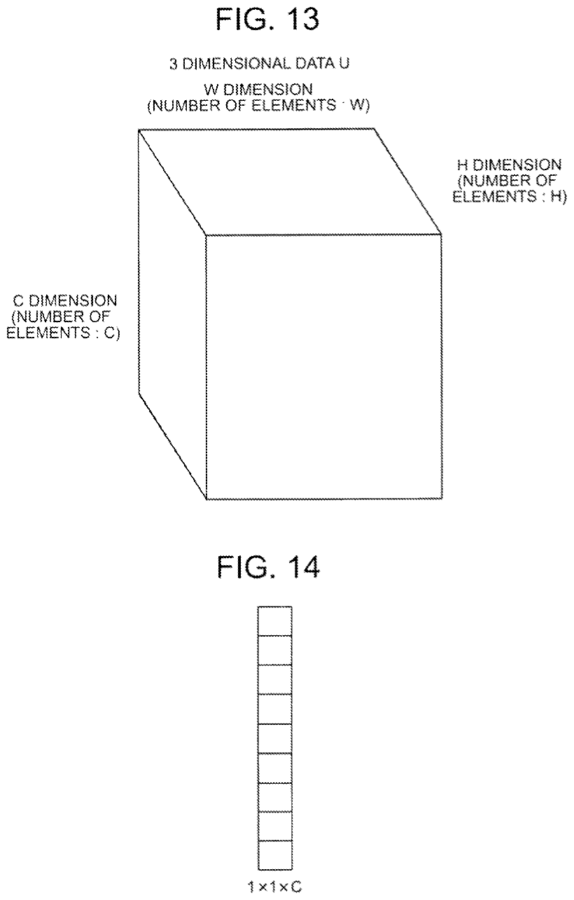

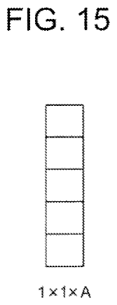

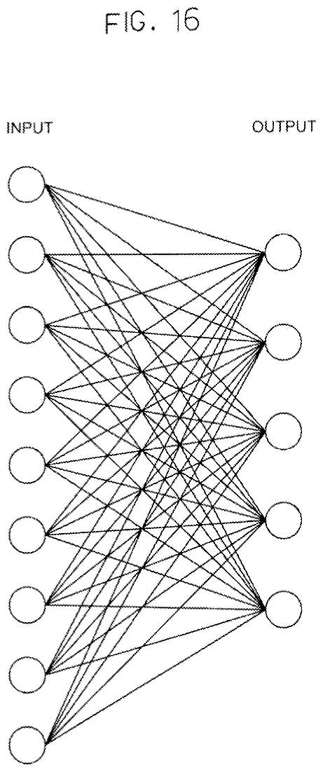

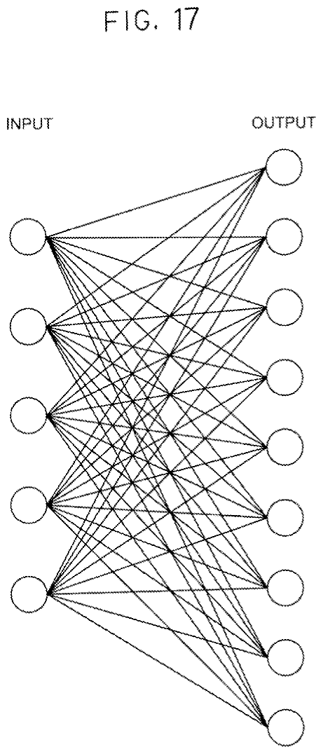

In the present example embodiment, the first 3 dimensional data is input to the multidimensional data generation device 1, and the multidimensional data generation device 1 generates 3 dimensional data in which the number of elements of the C dimension is C, the number of elements of the H dimension is H, and the number of elements of the W dimension is W. The number of elements of the C dimension “C” in the generated 3 dimensional data is the same as the number of elements of the C dimension (the dimension of channel) in the first 3 dimensional data. The number of elements of the H dimension “H” and the number of elements of the W dimension “W” in the generated 3 dimensional data are predetermined. In other words, the number of elements of each dimension in the generated 3 dimensional data is predetermined according to the 3 dimensional data U (see FIG. 13) that is an input to the SE block.

The first multidimensional data input to the multidimensional data generation device 1 may be 2 dimensional data or multidimensional data of 4 or more dimensions, if the number of elements of the C dimension is C and the number of elements of each dimension other than the C dimension is 1. The multidimensional data generation device 1 may generate 2 dimensional data or multidimensional data of 4 or more dimensions as multidimensional data. However, the multidimensional data generation device 1 generates multidimensional data of n dimension when multidimensional data of n dimension is input.

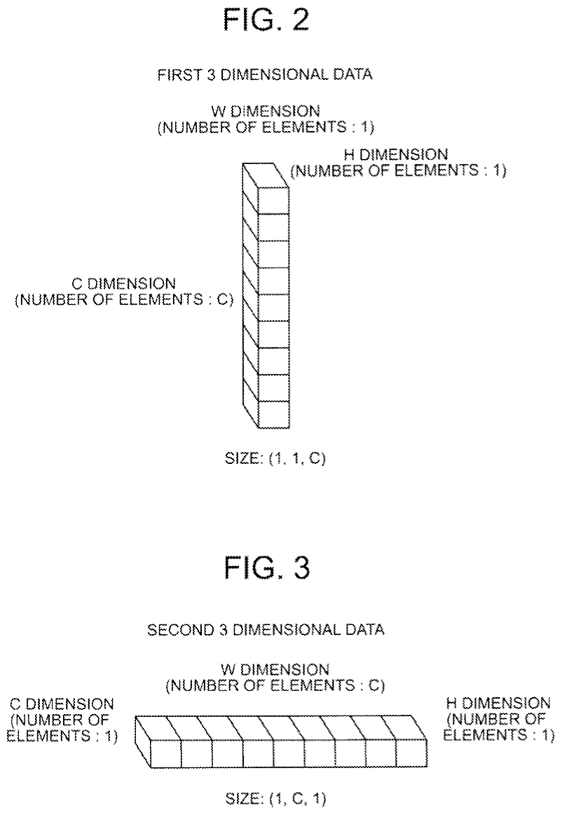

FIG. 2 is a schematic diagram showing an example of the first 3 dimensional data input to the multidimensional data generation device 1 in the present example embodiment.

When the first 3 dimensional data is input, the transformation unit 2 transforms the first 3 dimensional data into 3 dimensional data in which the number of elements of one dimension out of dimensions other than the C dimension (the dimension of channel) is C, and the number of elements of each dimension other than that one dimension is 1. In the present example embodiment, the case where “one dimension out of dimensions other than the C dimension” above is the W dimension will be used as an example, but it may also be the H dimension.

When “one dimension out of dimensions other than the C dimension” above is the W dimension, the transformation unit 2 transforms the first 3 dimensional data into 3 dimensional data in which the number of elements of the W dimension is C, and the number of elements of each of the other dimensions (the H dimension and the C dimension) is 1.

It is assumed that k is an integer from 0 to C−1. The transformation unit 2 transforms the first 3 dimensional data by replacing the element corresponding to the 0th of the H dimension, the 0th of the W dimension, and the kth of the C dimension in the first 3 dimensional data as the element corresponding to the 0th of the H dimension, the kth of the W dimension, and the 0th of the C dimension.

The multidimensional data after transformation by the transformation unit 2 is referred to as the second multidimensional data (in the present example embodiment, the second 3 dimensional data). FIG. 3 is a schematic diagram showing an example of the second 3 dimensional data.

The size of the first 3 dimensional data is (1, 1, C), while the size of the second 3 dimensional data is (1, C, 1) (see FIG. 2 and FIG. 3).

In the multidimensional data generated by the multidimensional data generation device 1 (3 dimensional data in the present example embodiment), the product of the predetermined number of elements for each dimension other than the C dimension (the dimension of channel) is N. In the present example embodiment, as mentioned above, the number of elements “H” in the H dimension and the number of elements “W” in the W dimension in the generated 3 dimensional data are predetermined. Therefore, N=H×W.

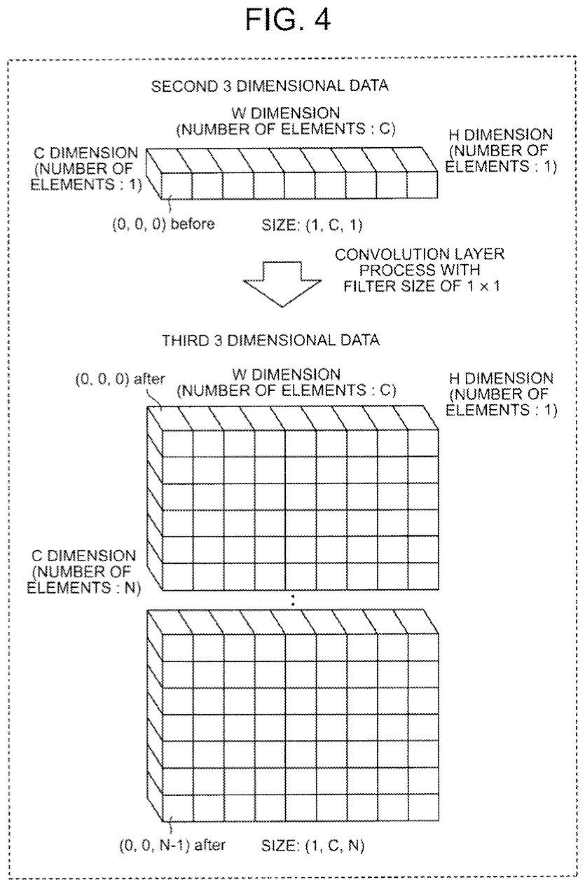

The channel dimension element number increase unit 3 generates 3 dimensional data in which the number of elements of the C dimension in the second 3 dimensional data is increased from 1 to N, by performing a convolution layer process with a filter size of 1×1 with a common value of N weights on the second 3 dimensional data. The multidimensional data generated by the channel dimension element number increase unit 3 is referred to as the third multidimensional data (in the present example embodiment, the third 3 dimensional data). The size of the third 3 dimensional data is (1, C, N). FIG. 4 is a schematic diagram showing the second 3 dimensional data and third 3 dimensional data.

The elements in the 3 dimensional data can be specified by their 3 dimension coordinates. Then, a value of the element specified by the H dimension coordinate h, the W dimension coordinate w, and the C dimension coordinate c in the second 3 dimensional data is expressed as (h, w, c)_{before}. Similarly, the value of the element specified by the H dimension coordinate h, the W dimension coordinate w, and the C dimension coordinate c in the third 3 dimensional data is expressed as (h, w, c)_{after}.

In the present example embodiment, there are N weights used in the convolution layer process with a filter size of 1×1, and the values of the N weights are all predetermined to be “ 1”. Therefore, the value of the N weights is 1 in common. The weights may be referred to as filter values.

It is assumed that i is an integer from 0 to N−1. The i-th weight is then written as tᵢ. t₀=t₁=t₂= . . . =tₙ₋₁=1. The weight tᵢ is used to calculate the value of each element of the i-th channel in the third 3 dimensional data.

For example, the channel dimension element number increase unit 3 calculates the value of (0, 0, 0)_{after} by the formula (1) shown below.

(0, 0, 0)_{after}=(0, 0, 0)_{before}×t₀ (1)

The channel dimension element number increase unit 3 also finds the values of the other elements of the 0th channel in the third 3 dimensional data by the same calculation, using the weights t₀.

The channel dimension element number increase unit 3 calculates the value of (0, 0, i)_{after} by the formula (2) shown below.

(0, 0, i)_{after}=(0, 0, 0)_{before}×tᵢ (2)

The channel dimension element number increase unit 3 also finds the values of the other elements of the i-th channel in the third 3 dimensional data by the same calculation, using the weights tᵢ.

Since t₀=t₁=t₂= . . . ==1, as mentioned above, all of (0, 0, 0)_{after}, (0, 0, 1)_{after}, . . . , (0, 0, N−1)_{after} are equal to (0, 0, 0)_{before}.

The channel dimension element number increase unit 3 uses the above calculation to calculate the value of each element of the 0th channel, the value of each element of the 1st channel, . . . , the value of each element of the N−1th channel in the third 3 dimensional data. Then, the channel dimension element number increase unit 3 performs the same process at each position in the plane consisting of the H dimension and the W dimension in the second 3 dimensional data. In other words, the channel dimension element number increase unit 3 calculates the values of all elements in the third 3 dimensional data. Then, the channel dimension element number increase unit 3 derives the third 3 dimensional data. As a result, the third 3 dimensional data with size (1, C, N) is obtained.

It is assumed that j is an integer from 0 to C−1. As in the previous case, all of (0, j, 0)_{after}, (0, j, 1)_{after}, . . . , (0, j, N−1)_{after} are equal to (0, j, 0)_{before}.

The transposition unit 4 performs a predetermined transposition on the third 3 dimensional data generated by the channel dimension element number increase unit 3 so that the number of elements of the C dimension (the dimension of channel) becomes C.

Here, the transposition will be explained. The transposition is the operation of shifting the position of elements in multidimensional data by changing the order of coordinates in multidimension coordinates when the elements in multidimensional data are expressed in multidimension coordinates. The following is a specific explanation using 3 dimensional data as an example.

It is assumed that when h denotes the coordinates of the H dimension, w denotes the coordinates of the W dimension, and c denotes the coordinates of the C dimension, the element in the 3 dimensional data specified by the coordinates (h, w, c) is denoted as p(h, w, c). In addition, coordinates that rearrange the order of coordinates within (h, w, c) are considered to be, for example, (h, c, w). In this case, the operation of moving p(h, w, c) to p(h, c, w) is an example of transposition.

As a transposition such that the number of elements of the C dimension becomes C, the transposition unit 4 may perform a transposition on the third 3 dimensional data, moving p(h, w, c) to p(h, c, w) for the third 3 dimensional data. Alternatively, the transposition unit 4 may perform a transposition moving p(h, w, c) to p(c, h, w) for the third 3 dimensional data.

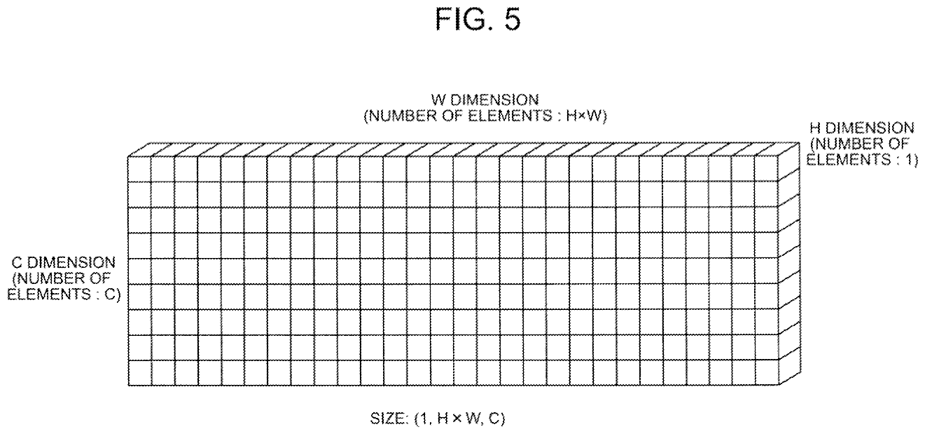

Here, first, the case where the transposition unit 4 performs a transposition on the third 3 dimensional data, moving p(h, w, c) to p(h, c, w) is shown. In this case, the size of the 3 dimensional data after the transposition is (1, N, C). In this case, the 3 dimensional data after the transposition is represented schematically as shown in FIG. 5. Note that N=H×W.

Based on the 3 dimensional data after the transposition, the generation unit 5 generates 3 dimensional data in which the number of elements of the C dimension is C and the number of elements of each dimension other than the C dimension is the predetermined number of elements. In the present example embodiment, based on the 3 dimensional data after the transposition, the generation unit 5 generates 3 dimensional data in which the number of elements of the C dimension is C, the number of elements of the H dimension is H, and the number of elements of the W dimension is W.

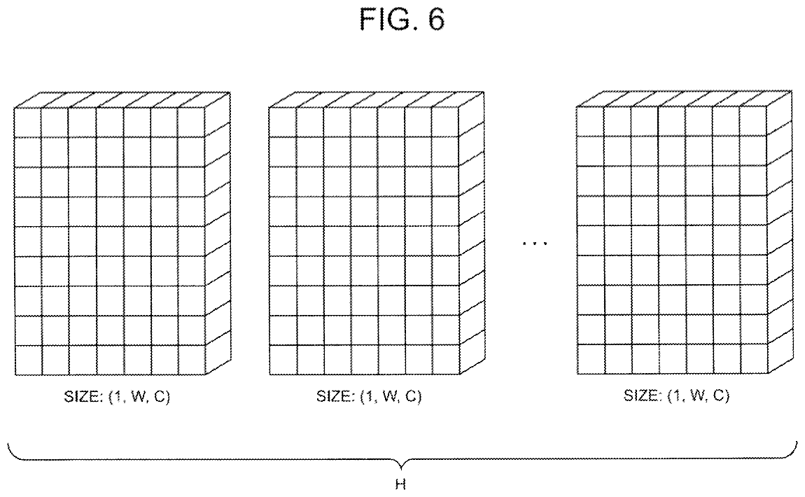

The generation unit 5, for example, generates H pieces of 3 dimensional data in which the number of elements of the H dimension is 1, the number of elements of the W dimension is W, and the number of elements of the C dimension is C (3 dimensional data whose size is (1, W, C)), by dividing the 3 dimensional data (3 dimensional data after transposing) shown schematically in FIG. 5 by W elements of the W dimension direction. FIG. 6 shows the state in which H pieces of 3 dimensional data with size (1, W, C) are generated by dividing the 3 dimensional data schematically shown in FIG. 5 as described above.

The generation unit 5 can generate the desired 3 dimensional data with size (H, W, C) by defining the H pieces of 3 dimensional data as the 0th to H−1st data in the H dimension, respectively. For example, the generation unit 5 may define the first 3 dimensional data obtained by dividing the 3 dimensional data after the transposition as described above as the 0th data of the H dimension, and the next 3 dimensional data as the 1st data of the H dimension, so that the obtained 3 dimensional data is sequentially defined as 0th to H−1st, thereby to generates the desired 3 dimensional data with size (H, W, C).

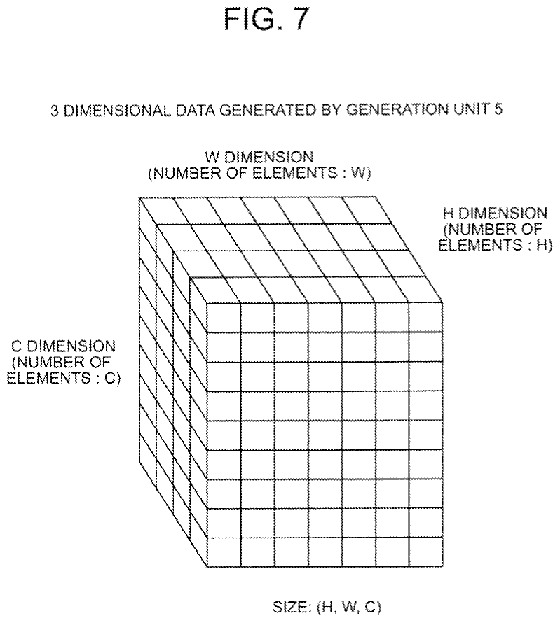

FIG. 7 is a schematic diagram showing the 3 dimensional data whose size is (H, W, C) generated by the generation unit 5.

The operation of generation unit 5 described above is an example of the operation to generate the 3 dimensional data shown in FIG. 7, and generation unit 5 may generate the 3 dimensional data shown in FIG. 7 by other operations based on the 3 dimensional data after the transposition is performed (see FIG. 5).

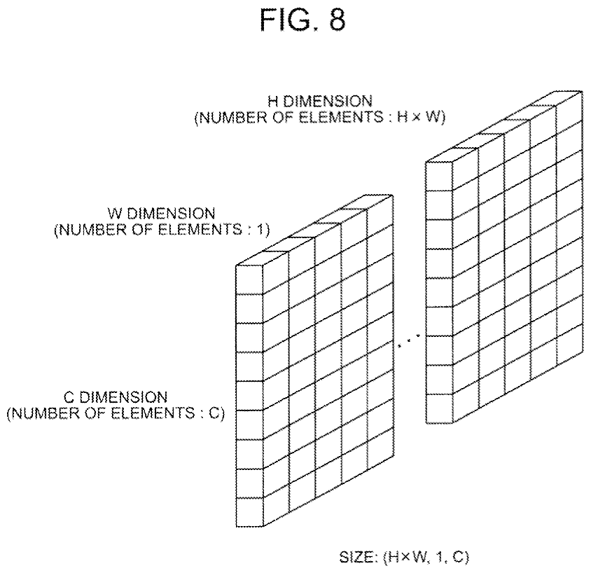

The above explanation describes the case where the transposition unit 4 transposes p(h, w, c) to p(h, c, w) for the third 3 dimensional data. Next, the case where the transposition unit 4 transposes p(h, w, c) to p(c, h, w) for the third 3 dimensional data is explained. In this case, the size of the 3 dimensional data after the transposition is (N, 1, C). In this case, the 3 dimensional data after the transposition is represented schematically as shown in FIG. 8. As mentioned above, N=H×W.

For example, the generation unit 5 generates W pieces of 3 dimensional data in which the number of elements of the H dimension is H, the number of elements of the W dimension is 1, and the number of elements of the C dimension is C (3 dimensional data whose size is (H, 1, C)), by dividing the 3 dimensional data (3 dimensional data after transposing) shown schematically in FIG. 8 by H elements of the H dimension direction.

The generation unit 5 can generate the desired 3 dimensional data with size (H, W, C) by defining the W pieces of 3 dimensional data as the 0th to W−1st data in the W dimension, respectively. For example, the generation unit 5 may define the first 3 dimensional data obtained by dividing the 3 dimensional data after the transposition as described above as the 0th data of the W dimension, and the next 3 dimensional data as the 1st data of the W dimension, so that the obtained 3 dimensional data is sequentially defined as 0th to W−1st, thereby to generates the desired 3 dimensional data with size (H, W, C). In this case, the 3 dimensional data expressed as shown in FIG. 7 is also obtained.

In this case, too, the operation of generation unit 5 described above is an example of the operation to generate the 3 dimensional data shown in FIG. 7, and generation unit 5 may generate the 3 dimensional data shown in FIG. 7 by other operations based on the 3 dimensional data after the transposition is performed (see FIG. 8).

As explained above, the transposition performed by transposition unit 4 on the third 3 dimensional data may be the transposition that moves p(h, w, c) to p(h, c, w) or the transposition that moves p(h, w, c) to p(c, h, w).

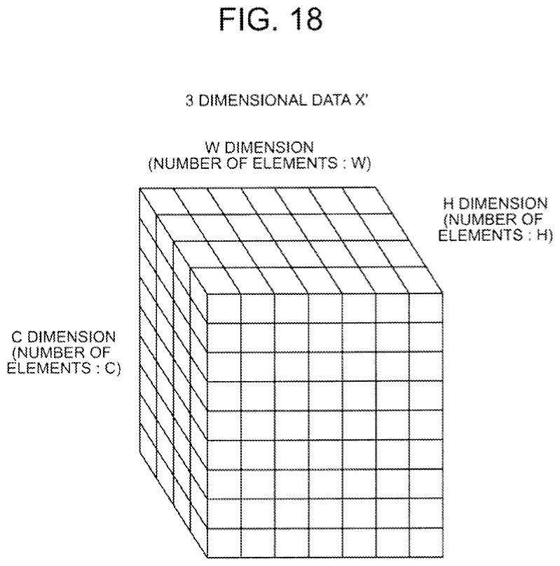

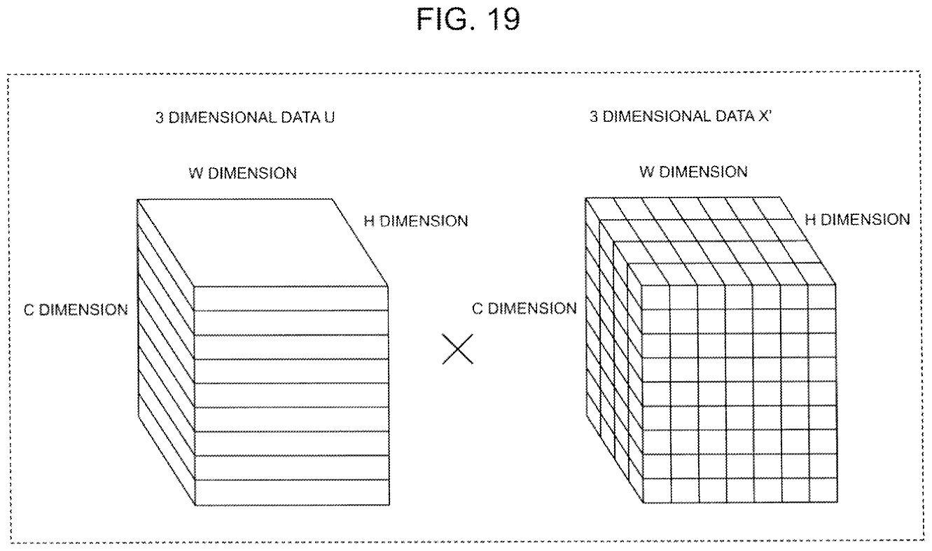

The generation unit 5 outputs the desired 3 dimensional data generated based on the 3 dimensional data after the transposition, whose size is (H, W, C) (see FIG. 7) to outside. For example, the generation unit 5 outputs the generated 3 dimensional data (see FIG. 7) to a device that executes element-wise product in the SE block (hereinafter referred to as an element-wise product calculation device. The figure is omitted.). The 3 dimensional data (see FIG. 7) generated by the generation unit 5 is the same 3 dimensional data as the aforementioned 3 dimensional data X′ (see FIG. 18). Therefore, in the calculation of the element-wise product with the 3 dimensional data U in the SE block, the 3 dimensional data generated by the generation unit 5 may be used instead of the 3 dimensional data X′ (see FIG. 18). In other words, the element-wise product calculation device may calculate the element-wise product of the 3 dimensional data U and the 3 dimensional data generated by the generation unit 5.

The transformation unit 2, the channel dimension element number increase unit 3, the transposition unit 4, and the generation unit 5 are realized, for example, by a CPU (Central Processing Unit) of a computer operating according to a multidimensional data generation program. For example, the CPU may read the multidimensional data generation program from a program storage medium such as a program storage device of the computer, and operate as the transformation unit 2, the channel dimension element number increase unit 3, the transposition unit 4, and the generation unit 5 according to the multidimensional data generation program. The channel dimension element number increase unit 3 may be realized by a dedicated circuit specialized for convolution layer process.

The transformation unit 2, the channel dimension element number increase unit 3, the transposition unit 4, and the generation unit 5 may each be realized by separate hardware. Moreover, as described above, the channel dimension element number increase unit 3 may be realized by a dedicated circuit specialized for convolution layer process.

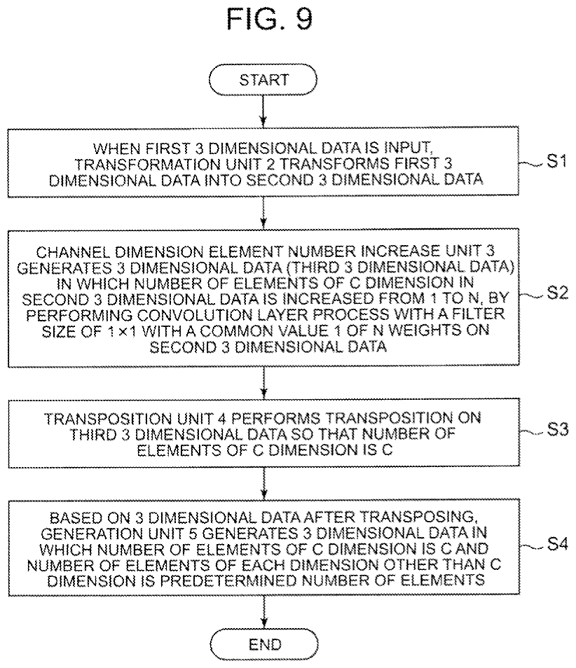

Next, the processing flow will be described. FIG. 9 is a flowchart showing an example of the processing flow of the example embodiment of the present invention. Detailed explanations of matters already explained will be omitted.

When the first 3 dimensional data is input, the transformation unit 2 transforms the first 3 dimensional data into the second 3 dimensional data (step S1).

The first 3 dimensional data is the output data of the Sigmoid layer in the SE block. In the first 3 dimensional data, the number of elements of the C dimension is C, and the number of elements of each dimension other than the C dimension (H dimension, W dimension) is 1 (see FIG. 2). In the present example embodiment, in the second 3 dimensional data, the number of elements of the W dimension is C, and the number of elements of the other dimensions (H dimension and C dimension) is 1 (see FIG. 3).

The transformation unit 2 may transform the first 3 dimensional data into the second 3 dimensional data, by replacing the element corresponding to the 0th of the H dimension, the 0th of the W dimension, and the kth of the C dimension in the first 3 dimensional data as the element corresponding to the 0th of the H dimension, the kth of the W dimension, and the 0th of the C dimension. Here, k is an integer from 0 to C−1.

Next to step S1, the channel dimension element number increase unit 3 generates 3 dimensional data (the third 3 dimensional data. see FIG. 4.) in which the number of elements of the C dimension in the second 3 dimensional data is increased from 1 to N, by performing a convolution layer process with a filter size of 1×1 with a common value 1 of N weights on the second 3 dimensional data (step S2).

Next, the transposition unit 4 performs transposition on the third 3 dimensional data so that the number of elements of the C dimension is C (step S3). The transposition performed by transposition unit 4 on the third 3 dimensional data may be the transposition that moves p(h, w, c) to p(h, c, w) or the transposition that moves p(h, w, c) to p(c, h, w).

Next to step S3, based on the 3 dimensional data after the transposition (see FIG. 5 or FIG. 8), the generation unit 5 generates 3 dimensional data in which the number of elements of the C dimension is C and the number of elements of each dimension other than the C dimension (the H dimension, the W dimension) is the predetermined number of elements (step S4). In the present example embodiment, the generation unit 5 generates 3 dimensional data whose size is (H, W, C), as illustrated in FIG. 7.

The generation unit 5 outputs the generated 3 dimensional data to, for example, the element-wise product calculation device (The figure is omitted). The element-wise product calculation device may calculate the element-wise product of the 3 dimensional data U (see FIG. 13), which is input to the SE block, and the 3 dimensional data generated by the generation unit 5 (see FIG. 7), and define the 3 dimensional data obtained by the calculation of the element-wise product as the output data of the SE block.

According to the present example embodiment, when the first 3 dimensional data is input, the transformation unit 2 transforms the first 3 dimensional data into the second 3 dimensional data. Then, the channel dimension element number increase unit 3 generates 3 dimensional data (the third 3 dimensional data) in which the number of elements of the C dimension in the second 3 dimensional data is increased from 1 to N(=H×W), by performing a convolution layer process with a filter size of 1×1 on the second 3 dimensional data. The transposition unit 4 performs the transposition on the third 3 dimensional data, and the generation unit 5 generates 3 dimensional data whose size is (H, W, C), based on the 3 dimensional data after the transposition.

Thus, the multidimensional data generation device 1 in the present example embodiment generates the 3 dimensional data (see FIG. 7) which is similar to the aforementioned 3 dimensional data X′ (see FIG. 18), without executing the copy process. Therefore, no overhead is incurred by the copy process. Moreover, in the present example embodiment, the channel dimension element number increase unit 3 performs convolution layer process. The execution speed of the convolution layer process is very fast. Therefore, according to the present example embodiment, when the first 3 dimensional data is given, the 3 dimensional data (see FIG. 7), in which the number of elements of C dimension is same as the first 3 dimensional data, and the number of elements of each dimension other than the C dimension is predetermined, can be generated at high speed.

In other words, according to the present example embodiment, when the 3 dimensional data in which the number of elements of the C dimension is C and the number of elements of each dimension other than the C dimension (H dimension and W dimension) is 1 is given, the 3 dimensional data in which the number of elements of the C dimension is C and the number of elements of each dimension other than the C dimension (H dimension and W dimension) is predetermined, can be generated at high speed.

Therefore, by using the multidimensional data generation device 1 in the present example embodiment, the processing speed of the SE block can be increased.

The 3 dimensional data generated by the multidimensional data generation device 1 of the present example embodiment may not be intended to be used for the calculation of the element-wise product with the 3 dimensional data U (see FIG. 13). In other words, the 3 dimensional data generated by the multidimensional data generation device 1 of the present example embodiment may be applied to techniques other than SE blocks.

Next, a variation of the example embodiment of the invention will be described.

The above example embodiment describes the case where the values of the N weights in the convolution layer process with a filter size of 1×1 performed by the channel dimension element number increase unit 3 are “1”. The values of the N weights in the convolution layer process with a filter size 1×1 performed by the channel dimension element number increase unit 3 may be common with a predetermined value other than “1”. Hereafter, this predetermined value is referred to as α.

That is, the channel dimension element number increase unit 3 generates 3 dimensional data (the third 3 dimensional data) in which the number of elements of the C dimension in the second 3 dimensional data is increased from 1 to N, by performing a convolution layer process with a filter size of 1×1 with a common value α of N weights on the second 3 dimensional data. In this case, the value of each element in the third 3 dimensional data is α times the value of the corresponding element in the third 3 dimensional data in the aforementioned example embodiment.

Thus, in this case, for example, after generating the 3 dimensional data with size (H, W, C) based on the 3 dimensional data after the transposition, the generation unit 5 may divide the value of each element in the third 3 dimensional data by α. As a result, the same 3 dimensional data as in the aforementioned example embodiment (see FIG. 7) is obtained.

In the aforementioned example embodiment, the case where the multidimensional data generation device 1 generates 3 dimensional data was shown. The multidimensional data generation device 1 may generate multidimensional data other than 3 dimensional data.

For example, it is assumed that the multidimensional data generation device 1 generates 4 dimensional data. In this case, 4 dimensional data is input to the multidimensional data generation device 1 as the first multidimensional data. The dimensions in this case are the H dimension, the W dimension, the T dimension, and the C dimension. The H dimension, the W dimension, and the C dimension are the same as the H dimension, the W dimension, and the C dimension in the aforementioned example embodiment. In this case, 4 dimensional data in which the number of elements of the C dimension is C and the size is (1,1,1,C) is input to the multidimensional data generation device 1 as the first multidimensional data.

The number of elements of the H dimension “H”, the number of elements of the W dimension “W”, and the number of elements of the T dimension “T” in the 4 dimensional data to be generated are predetermined. In this case, N=H×W×T.

The transformation unit 2 may transform the first multidimensional data into the second multidimensional data in the same way as in the aforementioned example embodiment.

In this case, 4 dimensional data with size (1, C, 1, N) is generated by the channel dimension element number increase unit 3, for example. Then, the transposition unit 4 performs a transposition, for example, moving p(h, w, t, c) to p(h, c, t, w) to p(h, w, t, c). Note that t is a T dimension coordinate. In this example, as the transposition results, 4 dimensional data with size (1, N, 1, C) is obtained. Then, the generation unit 5 divides the multidimensional data after the transposition by W elements of the W dimension direction, arranges the resulting multidimensional data in the H dimension, divides the multidimensional data by H elements of the H dimension direction, and arranges the resulting multidimensional data in the T dimension. The generation unit 5 can generate 4 dimensional data with size (H, W, T, C) by such a process. However, the process by which the generation unit 5 generates 4 dimensional data with size (H, W, T, C) is not limited to the above example.

Thus, the multidimensional data generation device 1 can be applied to the generation of multidimensional data other than 3 dimensional data.

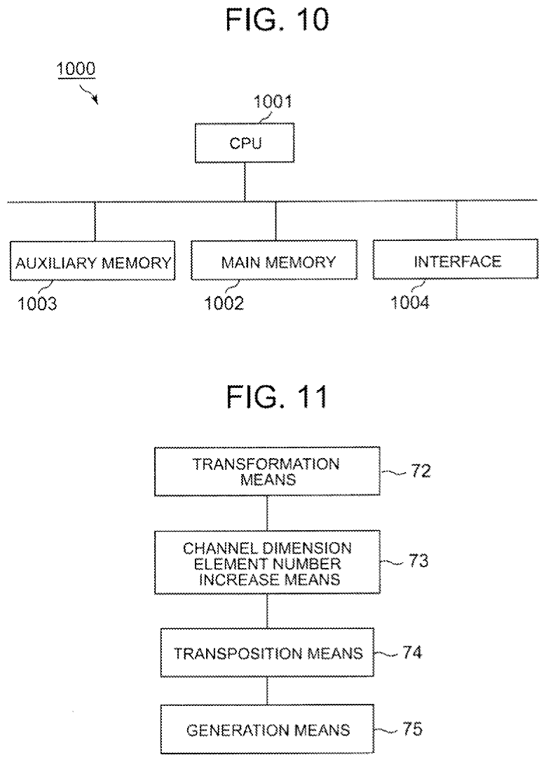

FIG. 10 is a schematic block diagram showing an example of computer configuration of the multidimensional data generation device 1 of the example embodiment of the present invention. The computer 1000 includes a CPU 1001, a main memory 1002, an auxiliary memory 1003, and an interface 1004.

The multidimensional data generation device 1 of the example embodiment of the present invention is realized by a computer 1000. The operation of the multidimensional data generation device 1 is stored in the auxiliary memory 1003 in the form of a multidimensional data generation program. The CPU 1001 reads the multidimensional data generation program from auxiliary memory 1003 and expands it to the main memory 1002, and executes the process described in the above example embodiment according to the multidimensional data generation program.

The auxiliary memory 1003 is an example of a non-transitory tangible medium. Other examples of non-transitory tangible media include magnetic disks connected via interface 1004, magneto-optical disks, CD -ROM (Compact Disk Read Only Memory), DVD-ROM (Digital Versatile Disk Read Only Memory), semiconductor memory, etc. When the program is delivered to the computer 1000 through a communication line, the computer 1000 may expand the program in the main memory 1002 and execute the process described in the above example embodiment according to the program.

Some or all of each of the components may be realized by general-purpose or dedicated circuitry, processor, or a combination of these. These may comprise a single chip or multiple chips connected via a bus. Some or all of each of the components may be realized by a combination of the above-mentioned circuitry, etc. and a program.

When some or all of each of components is realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

The following is an overview of the invention. FIG. 11 is a block diagram showing an overview of the multidimensional data generation device of the present invention. The multidimensional data generation device of the present invention includes transformation means 72, channel dimension element number increase means 73, transposition means 74, and generation means 75.

The transformation means 72 (e.g., the transformation unit 2) transforms first multidimensional data in which the number of elements of dimension of channel is C and the number of elements of each dimension other than the dimension of channel is 1 into second multidimensional data in which the number of elements of one dimension out of dimensions other than the dimension of channel is C and the number of elements of each dimension other than the one dimension is 1.

The channel dimension element number increase means 73 (e.g., the channel dimension element number increase unit 3) generates third multidimensional data in which the number of elements of the dimension of channel is increased from 1 to N, by performing a convolution layer process with a filter size of 1×1 with a common value of N weights on the second multidimensional data, when product of predetermined number of elements for each dimension other than the dimension of channel is N.

The transposition means 74 (e.g., the transposition unit 4) performs predetermined transposition on the third multidimensional data so that the number of elements of the dimension of channel becomes C.

The generation means 75 (e.g., the generation unit 5) generates multidimensional data in which the number of elements of the dimension of channel is C and the number of elements of each dimension other than the dimension of channel is predetermined number of elements, based on the multidimensional data after the predetermined transposition.

With such a configuration, it is possible to generate, when given multidimensional data in which the number of elements of the dimension of channel is C and the number of elements of each dimension other than the dimension of channel is 1, multidimensional data in which the number of elements of each dimension other than the dimension of channel is a predetermined number of elements rapidly.

The channel dimension element number increase means 73 may generate the third multidimensional data, by performing the convolution layer process with a filter size of 1×1 with a common value 1 of N weights on the second multidimensional data.

the channel dimension element number increase means 73 may generate the third multidimensional data, by performing the convolution layer process with a filter size of 1×1 with a common predetermined value of N weights on the second multidimensional data, and the generation means 75 may divides a value of each element in the multidimensional data by the predetermined value, after generating the multidimensional data.

The first multidimensional data, the second multidimensional data, the third multidimensional data, the multidimensional data after the predetermined transposition, and the multidimensional data generated by the generation means may be 3 dimensional data.

Although the present invention has been described above with reference to example embodiment, the present invention is not limited to the above example embodiment. Various changes may be made to the structure and details of the present invention, that may be understood by those skilled in the art within the scope of the present invention.

### INDUSTRIAL APPLICABILITY

The present invention is suitably applied to a multidimensional data generation device that generates multidimensional data.

### REFERENCE SIGNS LIST

1 Multidimensional data generation device

2 Transformation unit

3 Channel dimension element number increase unit

4 Transposition unit

5 Generation unit

What is claimed is:

1. A multidimensional data generation device comprising:
a transformation unit, implemented by a processor, and that transforms first multidimensional data in which the number of elements of dimension of channel is C and the number of elements of each dimension other than the dimension of channel is 1 into second multidimensional data in which the number of elements of one dimension out of dimensions other than the dimension of channel is C and the number of elements of each dimension other than the one dimension is 1;
a channel dimension element number increase unit, implemented by the processor, and that generates third multidimensional data in which the number of elements of the dimension of channel is increased from 1 to N, by performing a convolution layer process with a filter size of 1×1 with a common value of N weights on the second multidimensional data, when product of predetermined number of elements for each dimension other than the dimension of channel is N;
a transposition unit, implemented by the processor, and that performs for predetermined transposition on the third multidimensional data so that the number of elements of the dimension of channel becomes C; and
a generation unit, implemented by the processor, and that generates multidimensional data in which the number of elements of the dimension of channel is C and the number of elements of each dimension other than the dimension of channel is predetermined number of elements, based on the multidimensional data after the predetermined transposition.

2. The multidimensional data generation device according to claim 1,
wherein the channel dimension element number increase unit
generates the third multidimensional data, by performing the convolution layer process with a filter size of 1×1 with a common value 1 of N weights on the second multidimensional data.

3. The multidimensional data generation device according to claim 1,
wherein the channel dimension element number increase unit
generates the third multidimensional data, by performing the convolution layer process with a filter size of 1×1 with a common predetermined value of N weights on the second multidimensional data, and
the generation unit
divides a value of each element in the multidimensional data by the predetermined value, after generating the multidimensional data.

4. The multidimensional data generation device according to claim 1,
wherein the first multidimensional data, the second multidimensional data, the third multidimensional data, the multidimensional data after the predetermined transposition, and the multidimensional data generated by the generation unit are 3 dimensional data.

5. A multidimensional data generation method comprising:
transforming first multidimensional data in which the number of elements of dimension of channel is C and the number of elements of each dimension other than the dimension of channel is 1 into second multidimensional data in which the number of elements of one dimension out of dimensions other than the dimension of channel is C and the number of elements of each dimension other than the one dimension is 1;
generating third multidimensional data in which the number of elements of the dimension of channel is increased from 1 to N, by performing a convolution layer process with a filter size of 1×1 with a common value of N weights on the second multidimensional data, when product of predetermined number of elements for each dimension other than the dimension of channel is N;
performing predetermined transposition on the third multidimensional data so that the number of elements of the dimension of channel becomes C; and
generating multidimensional data in which the number of elements of the dimension of channel is C and the number of elements of each dimension other than the dimension of channel is predetermined number of elements, based on the multidimensional data after the predetermined transposition.

6. A non-transitory computer-readable recording medium in which a multidimensional data generation program is recorded, wherein the multidimensional data generation program causes a computer to execute:
a transformation process of transforming first multidimensional data in which the number of elements of dimension of channel is C and the number of elements of each dimension other than the dimension of channel is 1 into second multidimensional data in which the number of elements of one dimension out of dimensions other than the dimension of channel is C and the number of elements of each dimension other than the one dimension is 1;
a channel dimension element number increase process of generating third multidimensional data in which the number of elements of the dimension of channel is increased from 1 to N, by performing a convolution layer process with a filter size of 1×1 with a common value of N weights on the second multidimensional data, when product of predetermined number of elements for each dimension other than the dimension of channel is N;
a transposition process of performing predetermined transposition on the third multidimensional data so that the number of elements of the dimension of channel becomes C; and
a generation process of generating multidimensional data in which the number of elements of the dimension of channel is C and the number of elements of each dimension other than the dimension of channel is predetermined number of elements, based on the multidimensional data after the predetermined transposition.
